(19) United States
(12) Patent Application Publication
(10) Pub. No.: US 2023/0228146 A1
(43) Pub. Date: Jul. 20, 2023

(54) MAJOR BLIND

(71) Applicant: OLAYINKA ADEWUNMI ADEBIYI, BLOOMFIELD, NJ (US)

(72) Inventor: OLAYINKA ADEWUNMI ADEBIYI, BLOOMFIELD, NJ (US)

(21) Appl. No.: 16/402,230

(22) Filed: May 3, 2019

(30) Foreign Application Priority Data
May 3, 2019 (US) 16402230

(51) Int. Cl. E06B 9/386

(52) U.S. Cl. CPC E06B 9/386

(57) ABSTRACT

One-way windows blinds made from tinted material that allows a user inside a room to see through the windows blinds outside but prevents people outside to view inside. Windows blind are one way and can operated by a remote control.

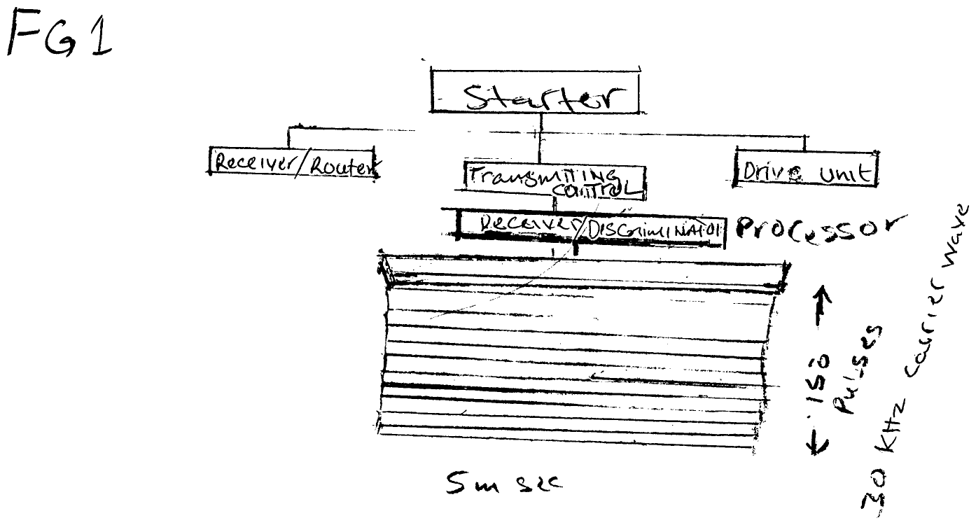

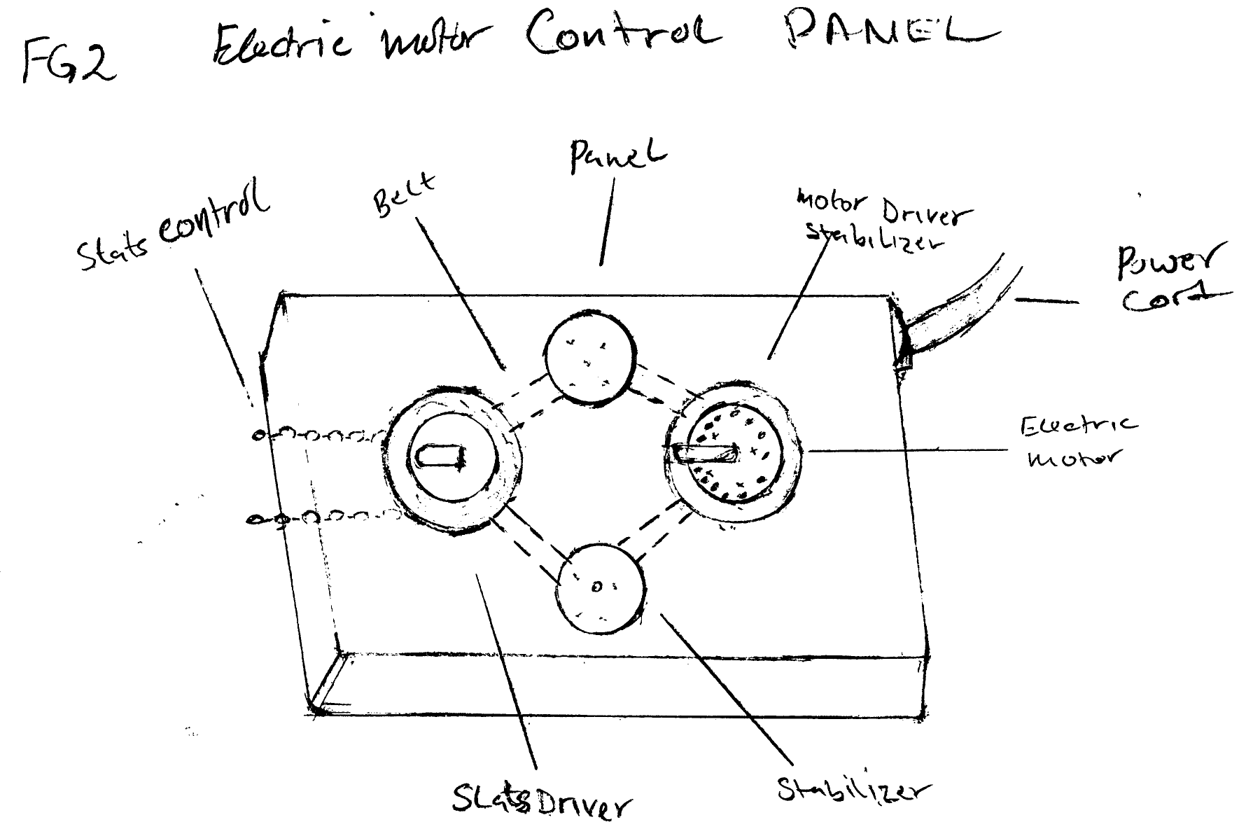

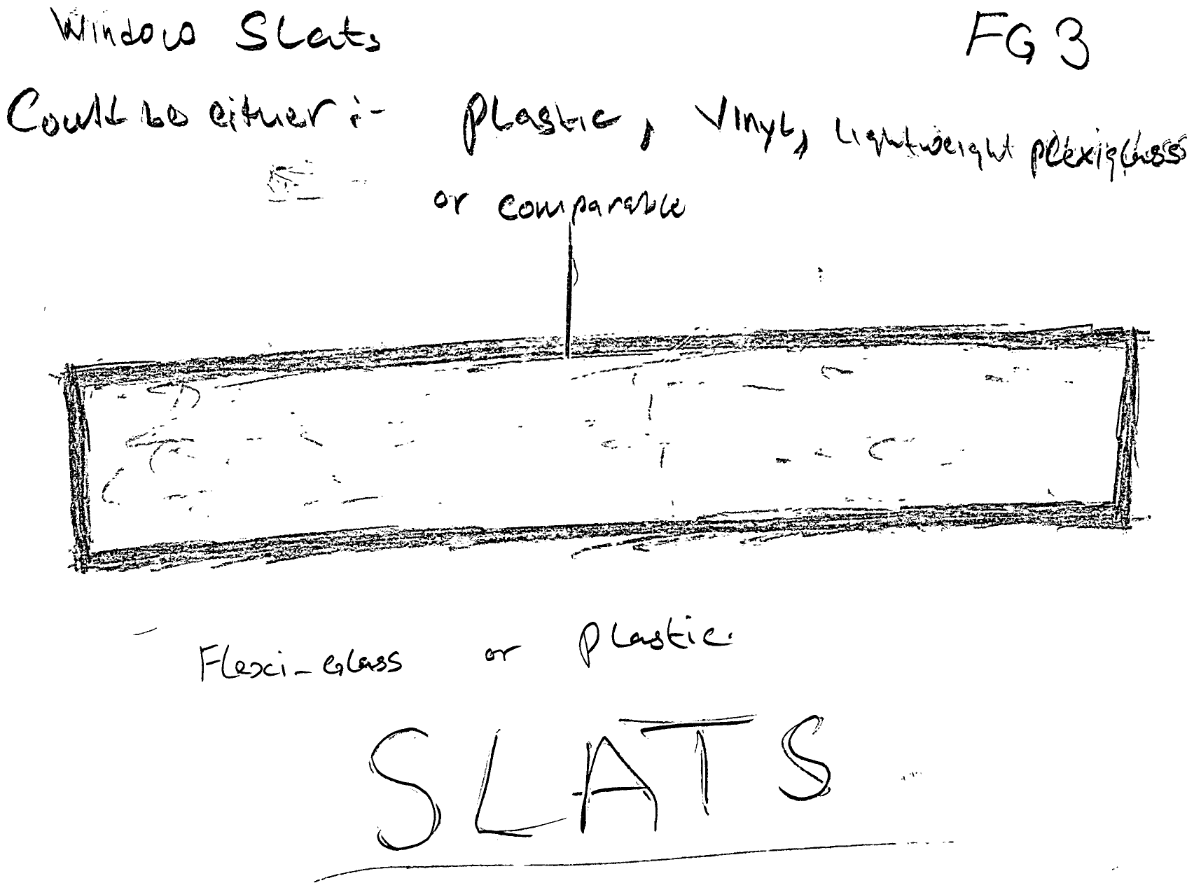

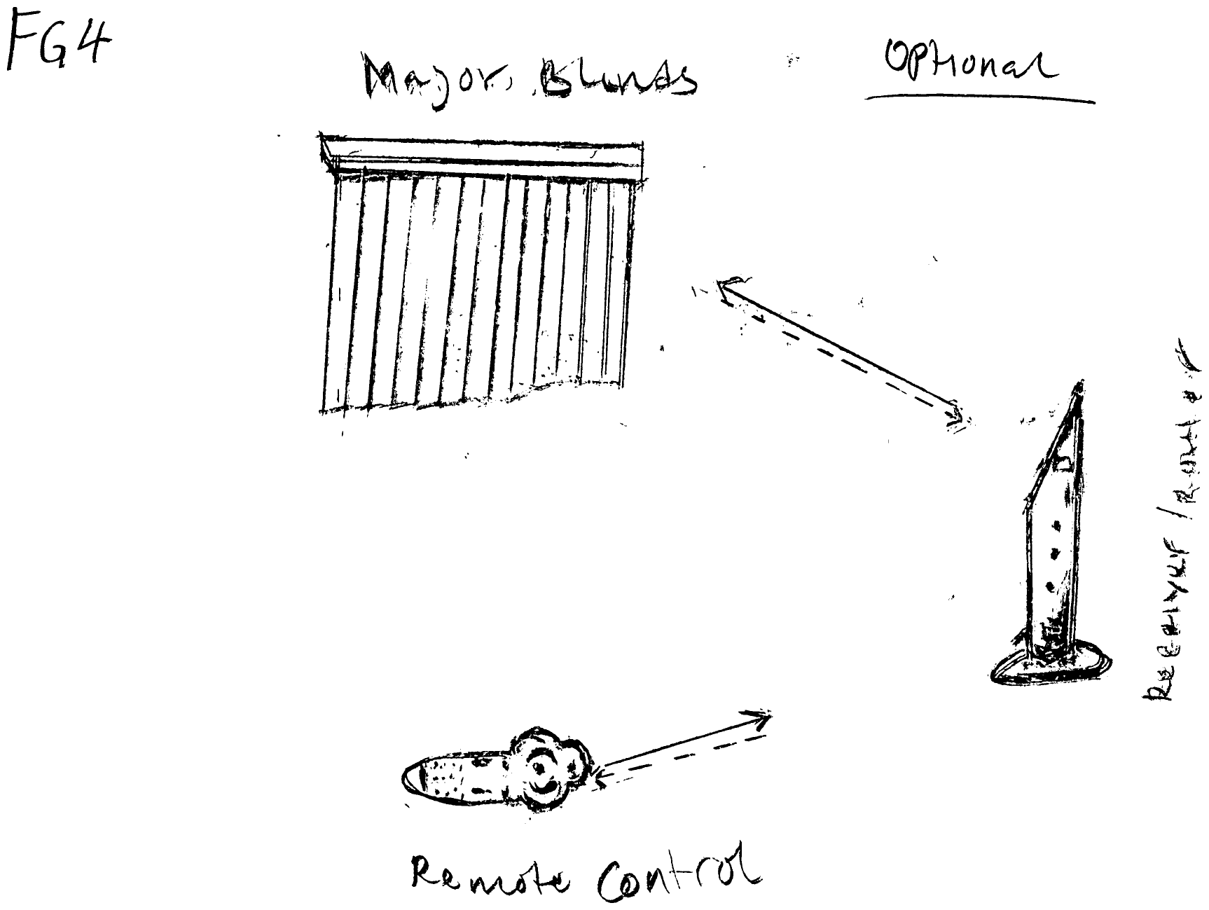

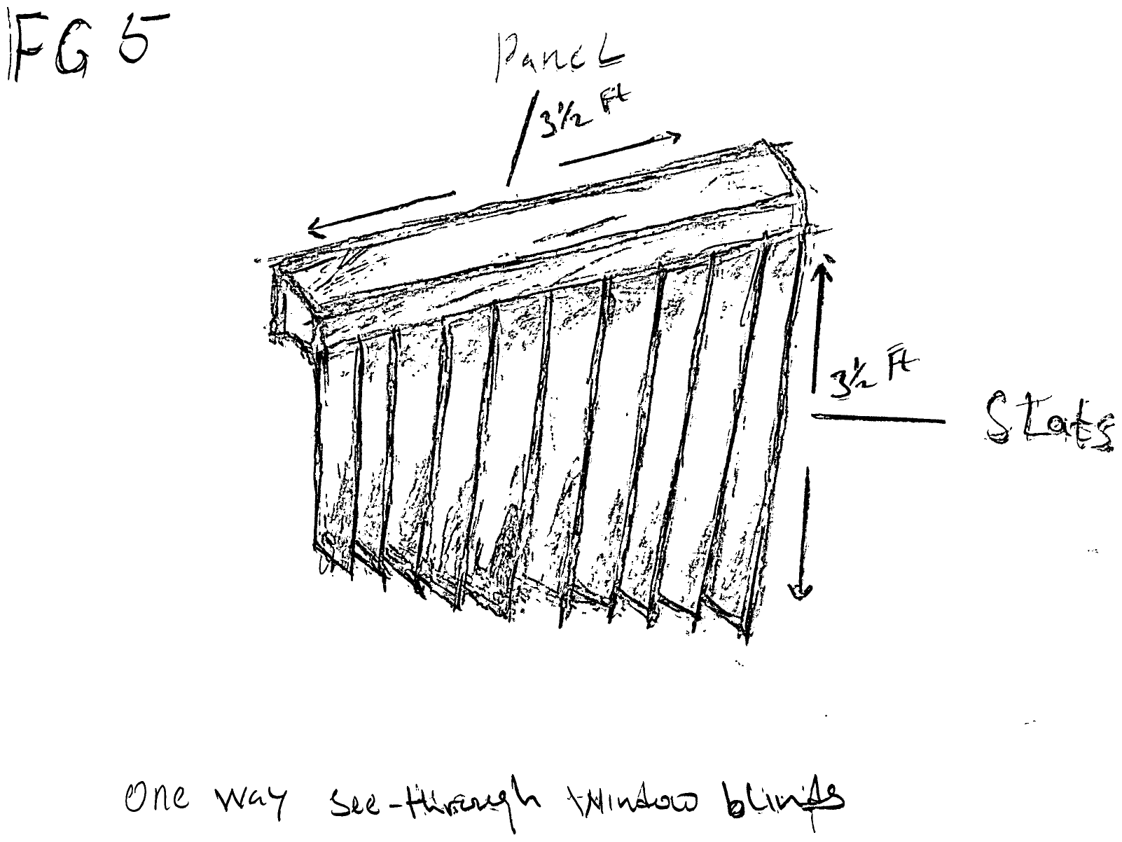

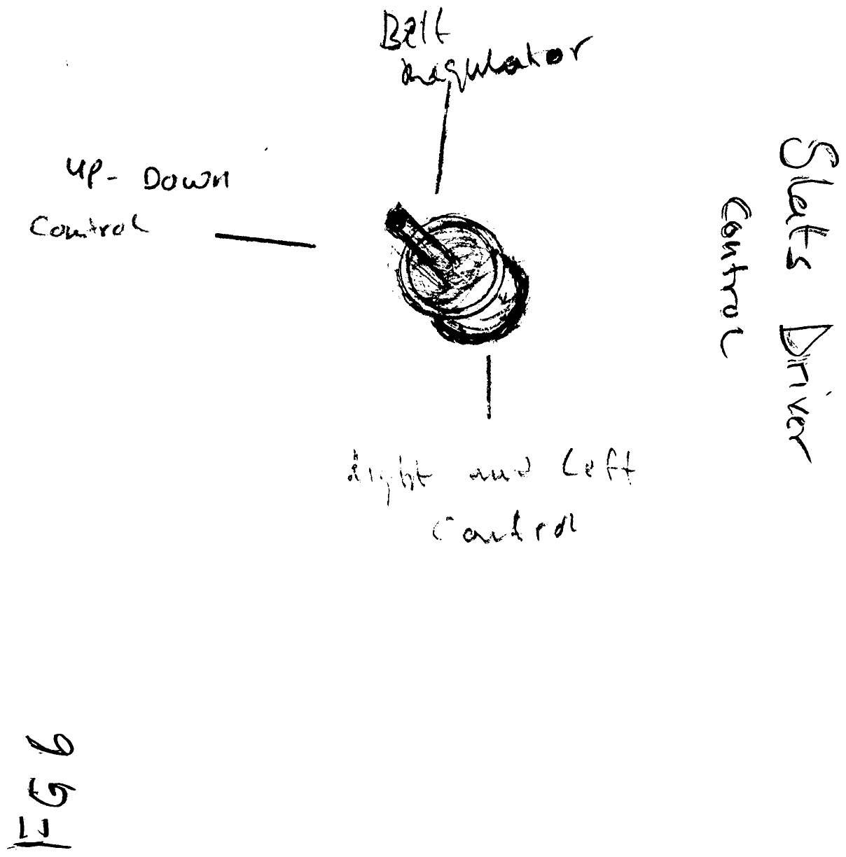

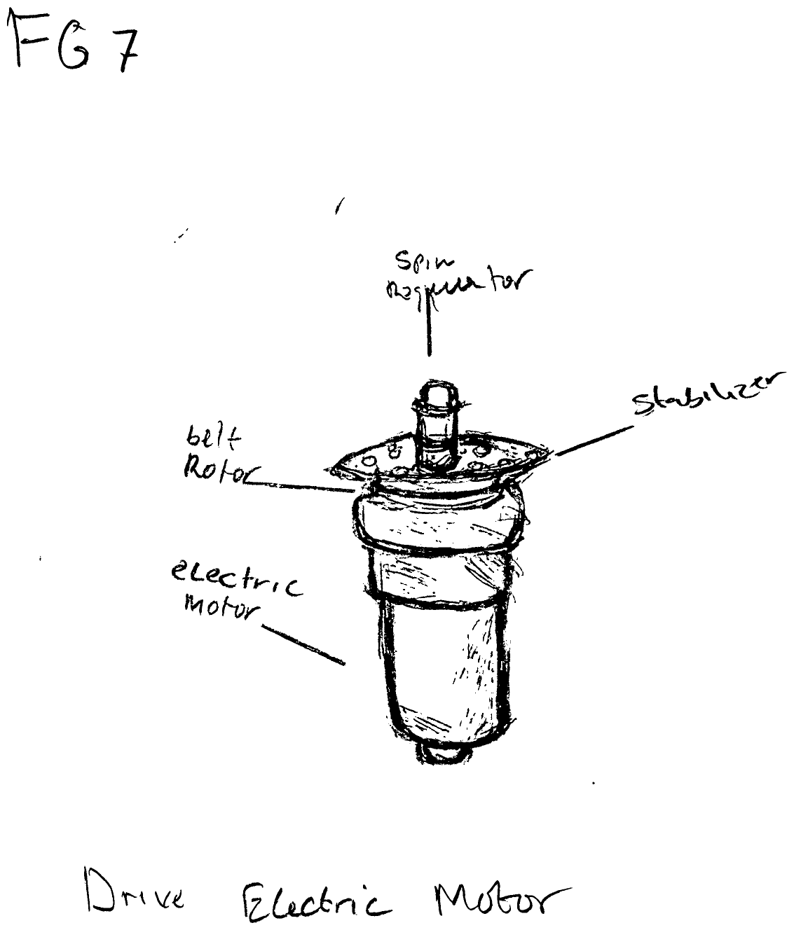

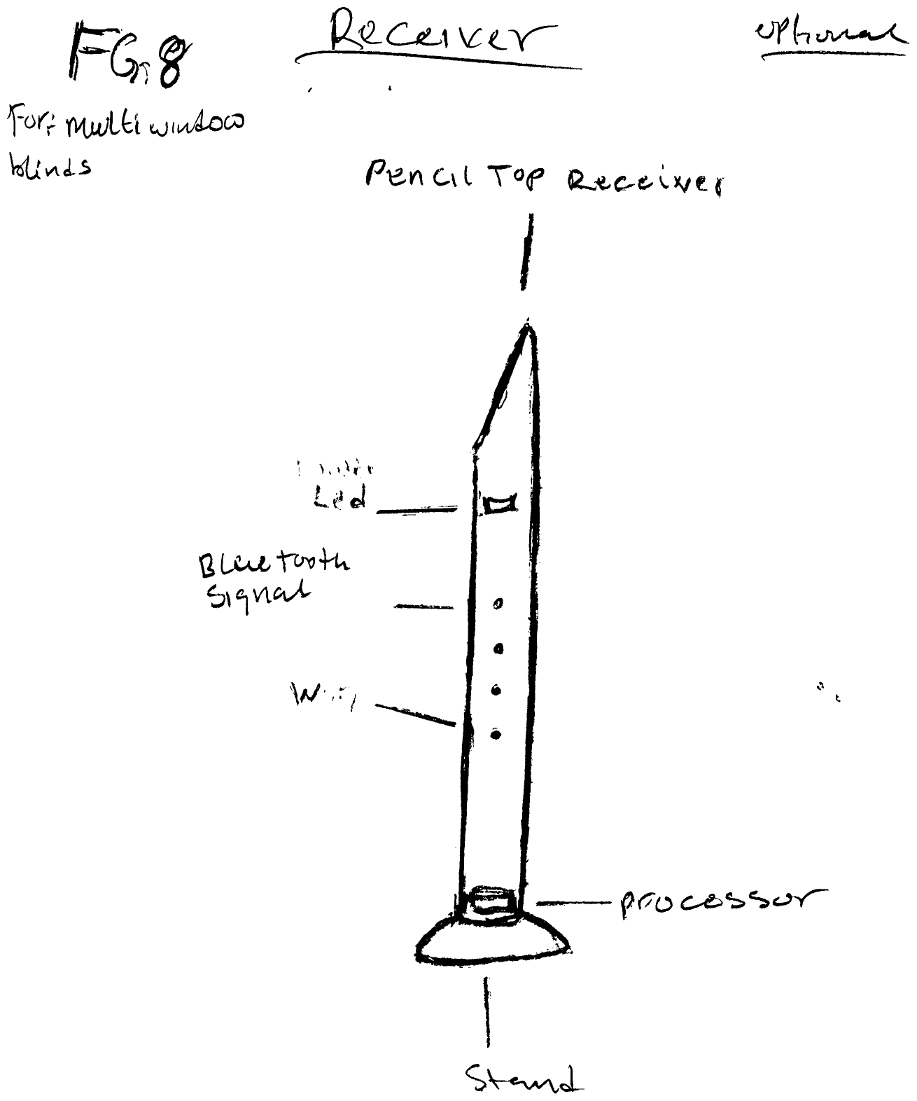

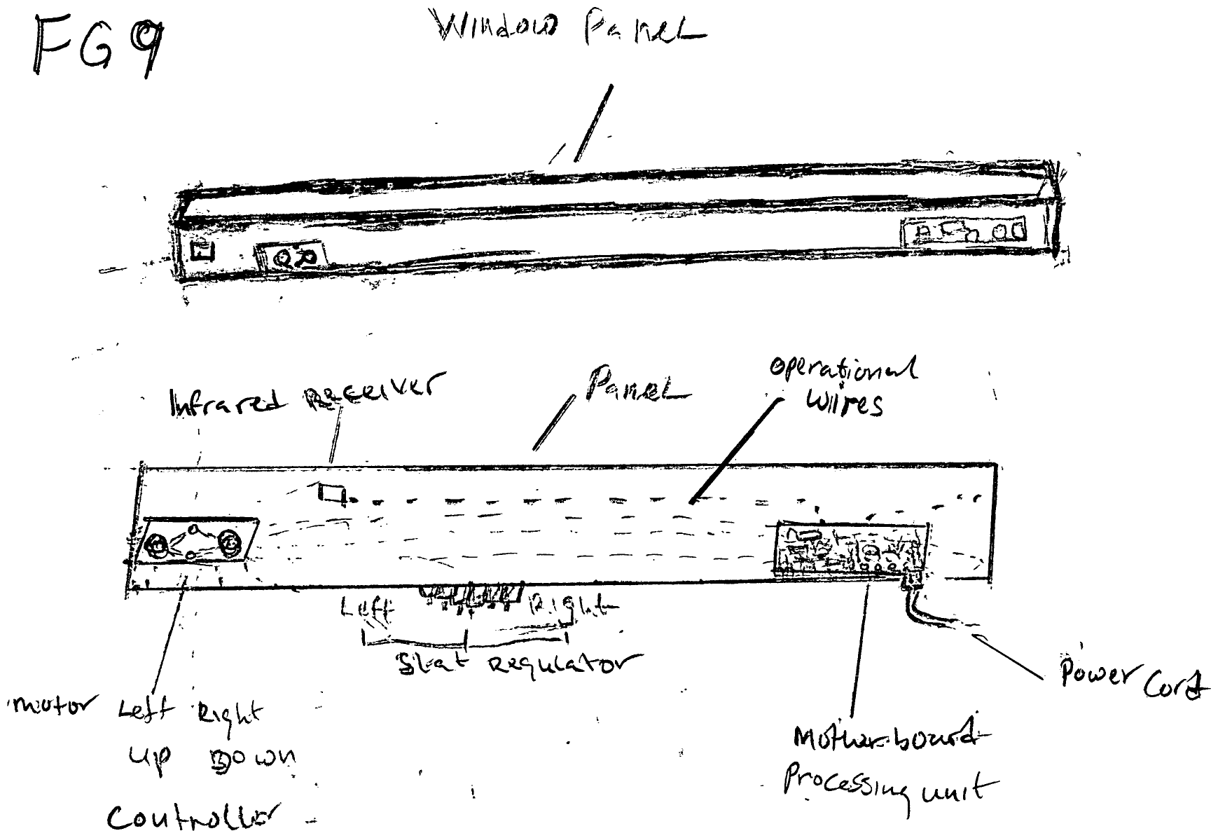

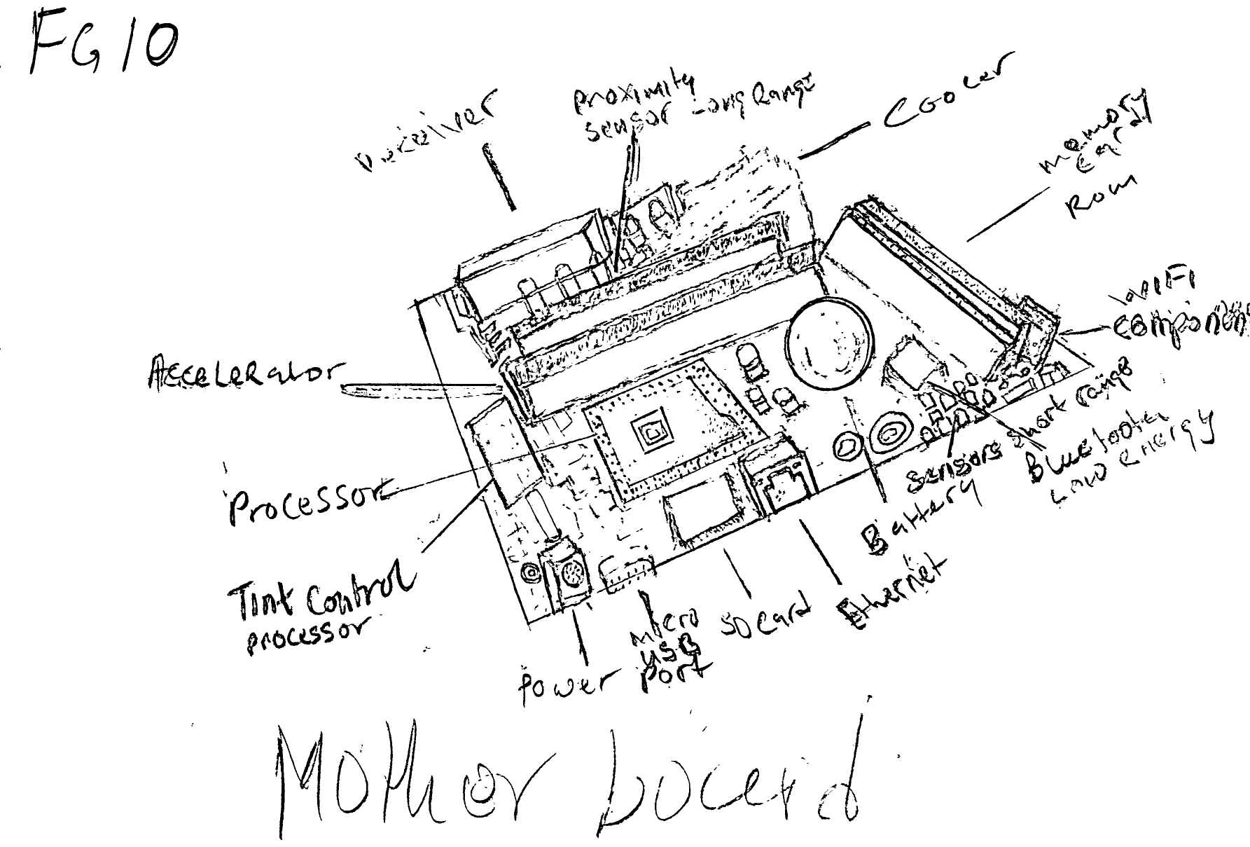

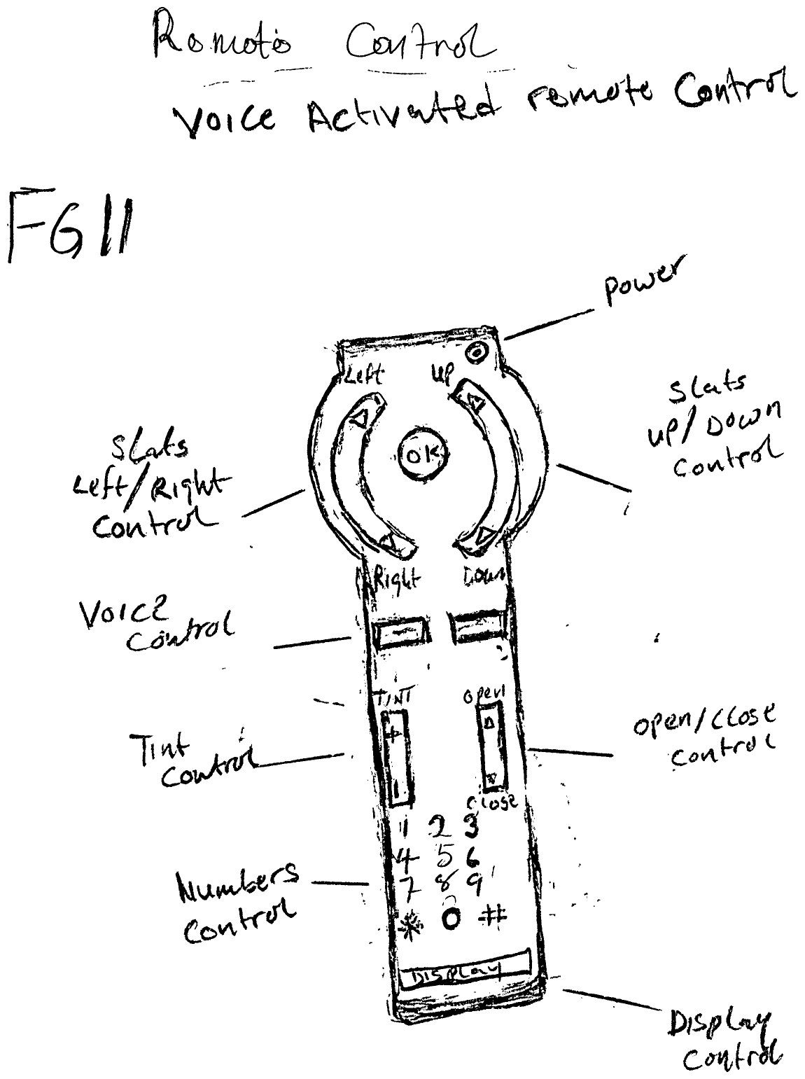

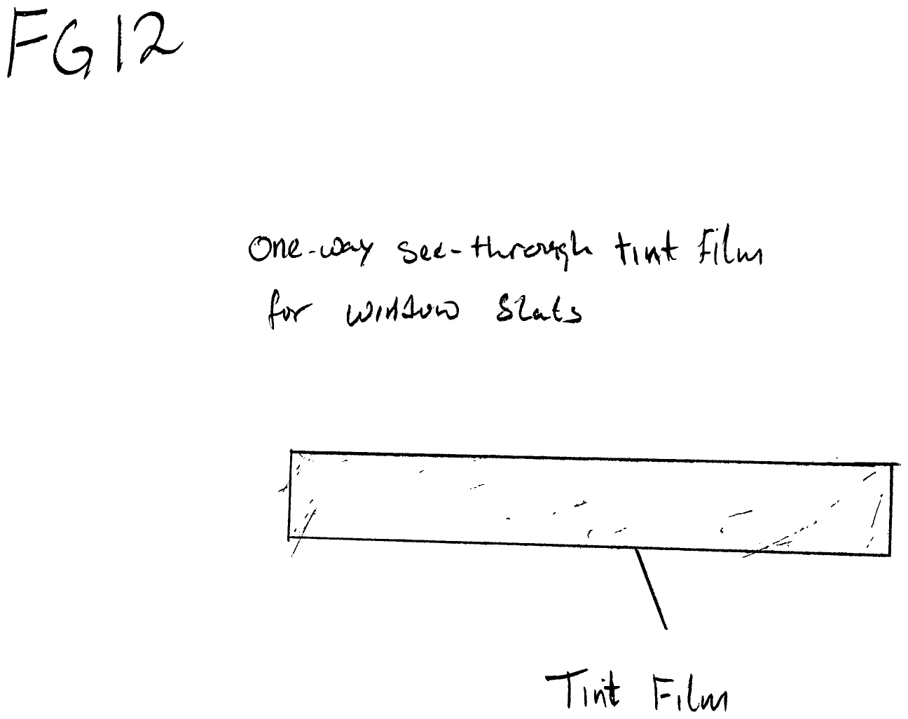

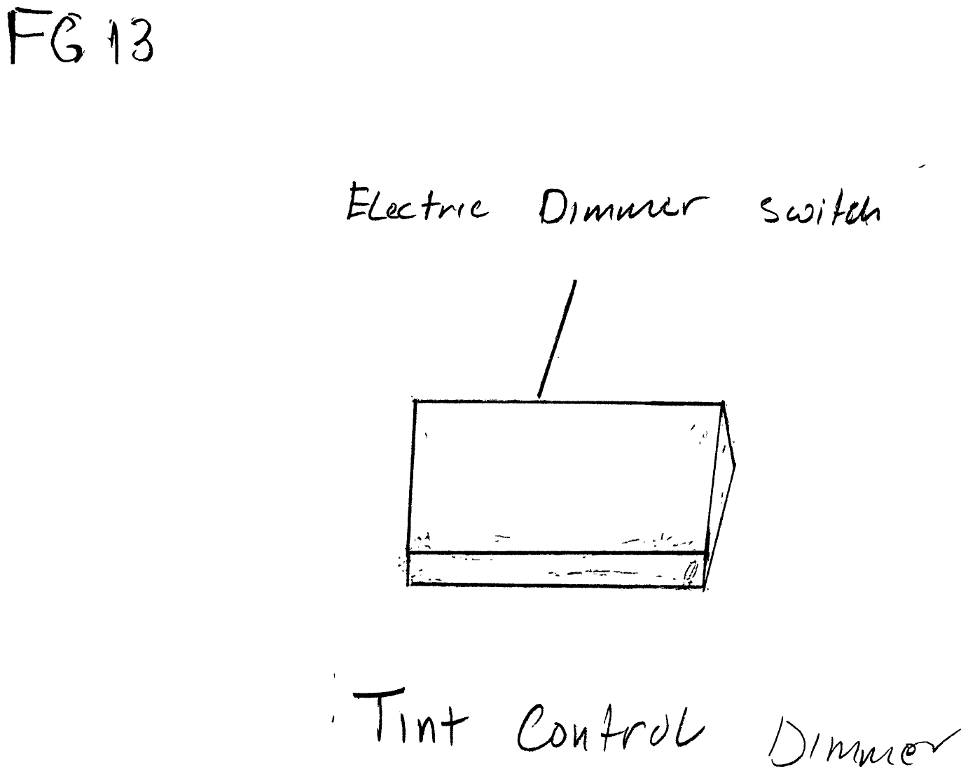

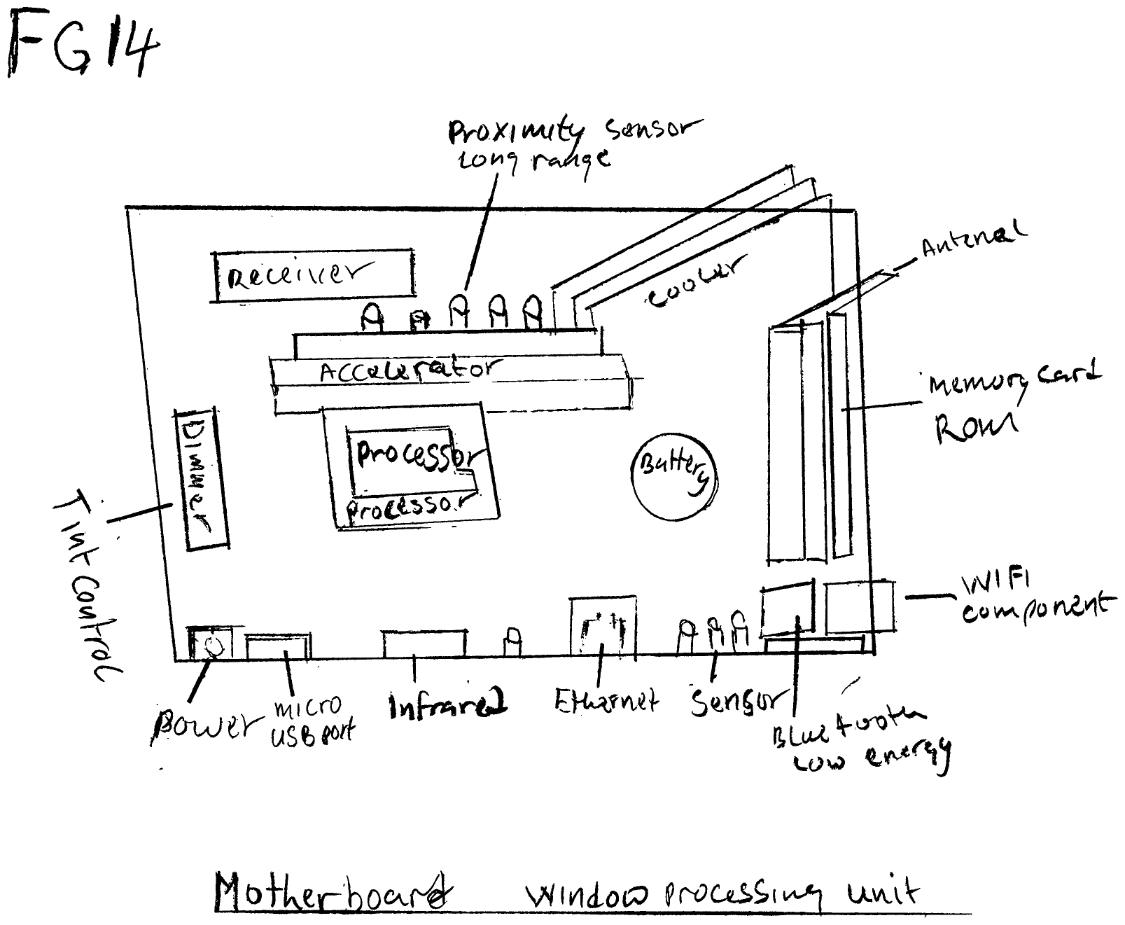

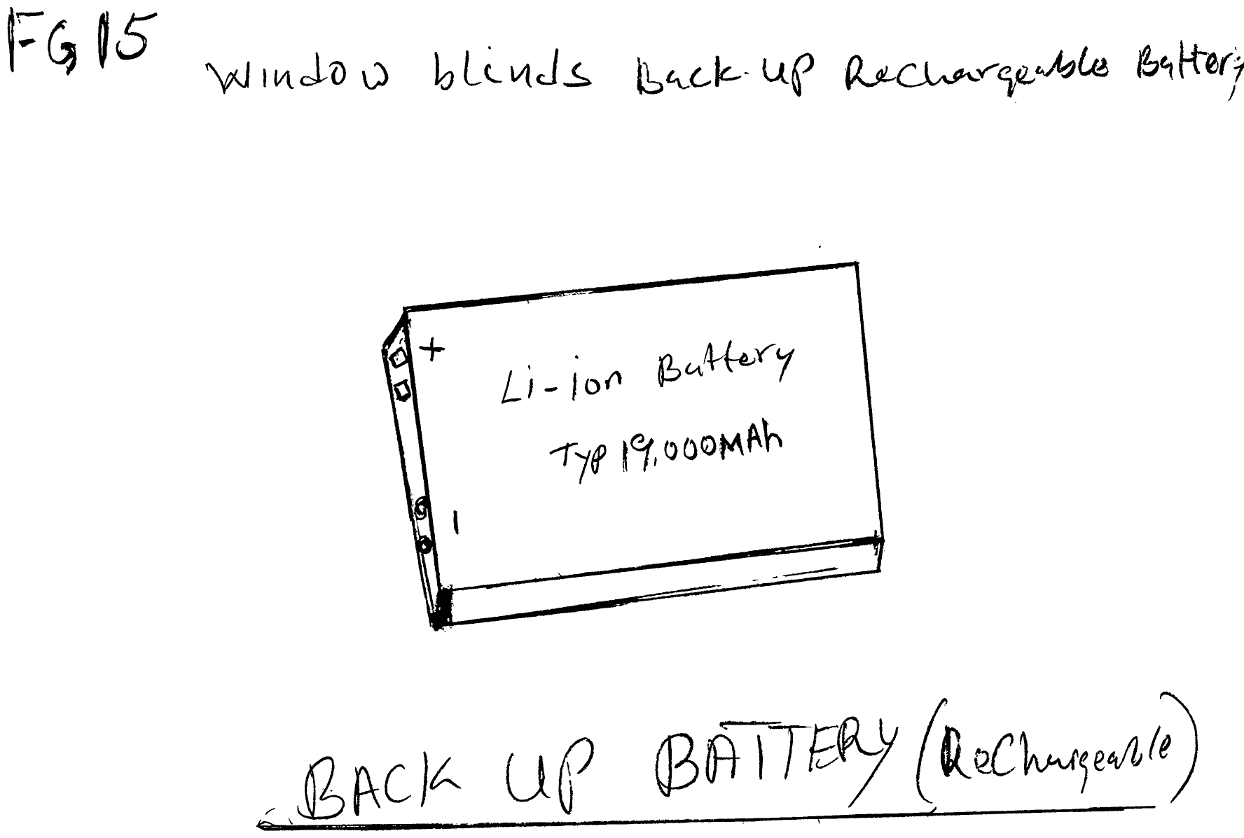

Invention spec: ELECTRONIC WINDOW BLINDS

Invention Focus: privacy and security plus an advantage of an unfettered view of the outdoors while preventing others from seeing inside with a UV-resistance materials and a use of a remote control.

Window treatments vary from home to home, but one common need is to prevent those spectators walking past from seeing inside. This new line of blinds is fully functional and will be appreciated by all users. Major blinds are a line of window blinds manufactured of a tint, UV-resistant material and an adjustable degree of tint. They are operated via a handheld remote control, computer, smartphone, communications via Bluetooth, Wi-Fi. The design intent is to provide consumers with an easy and convenient means of opening and closing their blinds and adjusting the degree of tint on the surface of the blinds to facilitate optimal comfort and an unfettered view of the outdoors while preventing others from seeing inside

Security is a vital component of safety in one's home and major blinds provides security in the one-way see through blinds, keeping out harsh sunlight but still allow the user to see outdoors with the blinds closed. Just like a one-way glass windows and there are no strings for kids or pets to get tangled in.

Remote control communicates with the blinds over the receiver and transmitter with the rate of movement of the window slats per seconds.

The Electric motor control panel consists of simple mechanism that drives the slats of the blinds back and forth, and up and down, the electric motor runs the drive that control the movement of the window slats.

The window slats is either a plastic or a lightweight plexiglass carefully designed to accommodate a one way blocking tint film and materials, UV-Ray resistant materials, Tint materials and a messaging technology materials.

the window blinds works with the pencil top receiver, this is optional, in most cases for a large room with multiple windows, the receiver act has a booster and a stabilizer for the blinds, with the use of pencil top receiver the window blinds can be program during installation to be individually identify by simply naming each blind, e.g. 1, 2, 3 window 1, window 2 etc. This gives the user the freedom to choose which window blind to communicate with. Using the remote control major blinds is a one way see through window blinds fits perfectly on most windows and doors, made with lightweight strong plastic panel and a lightweight plexiglass with a one-way blocking materials and a tint control materials with a short message receiving technology.

The window slats driver stabilizes the window slats movement and control the movement of the window slats, which opens and close the window. This is part of the electric motor panel components.

The Electric motor controls the movement of the window slats in conjunction with the slats driver for the opening and closing of the window. This component is in the window panel.

pencil Top Receiver (Optional), it's a booster and a router, it communicate with the active receiver already in the window panel and the processors in the motherboard to send a signal and messages to the window panel and slats and can individualize the windows via Wi-Fi and Bluetooth.

The window panel is the operating unit of the window blinds, here resides all operating components, the movement mechanism, motherboard and wires are stored and also the window slats are attached to it.

The motherboard is a mini computer operating system unit capable of an operating software and applications that handles the messages to the blinds and the tint control systems. This unit resides in the window panel.

The remote control device also has voice control capability, this device is use to operate the window blinds, it's has all the functionality and commands of the window blind. Fully equipped and operational.

The tint film is one of the materials that can be use to develop a one-way see-through window slats, like the same technology use for the police interrogation room window.

The Electric dimmer switch is a component of the motherboard that controls the level of tint of the window blinds, the tint dimmer operates from lightest to darkest.

This is the illustrations of the window blinds operating system unit. The motherboard and it's component's descriptions.

The Rechargeable back up battery can power the window blinds for at least 24 hours without the connection of a natural energy supply, it's a powerful Li-ion battery type 19000 mAh, can power the window blinds individually. Part of the components of the window panel.

The major blinds.

### FEATURES & BENEFITS

Major Blind could be configured with either vertical or horizontal slats, with the slats themselves manufactured of a lightweight, UV-resistant plexiglass, glass, vinyl, plastic or comparable, clear, tinted material. The tinted material that comprises the blind slats would be configured so that the surface of the blinds would be see-thru when fully closed in a similar manner as if peering through tinted auto glass, yet the exterior of the blinds would obstruct the view of the interior of the room in which the blinds are installed in similar effect to one way glass. In this manner, Major Blinds would provide an unfettered view of the outdoors, even when the blinds are closed, thus protecting the user's privacy and personal security in the process. The tint offered in the Major Blinds lines could include standard adjustable window tint, or this see-through tint could be made available in a variety of colors to compliment various home decors. Importantly, this tint would be fully adjustable, with varying degrees of tint ranging from lightest to darkest, with this tint modified via remote control. This same remote would also serve to control the movement of the blinds. Unlike standard window treatments, Major Blinds would not contain the turning rod or pull string common to those models, rather, they would connected to an electronic motor that adjusts to the positioning of the blinds, on demand, by remote control. As such, the Major Blinds would feature an electronic receiver circuit along with a tuned frequency necessary for the remote operation of the window blinds. The remote would be rectangular

in shape and comparable in size to a standard television remote control device. Located on the front if this remote would be a simple on/off switch, as well as directional buttons for use in raising, lowering and opening and closing the blinds. Operational settings would also be included for controlling the degree of tint of the individual blind slats. The remote could be battery powered or rechargeable. A designated software application would enable the user to control the Major Blinds through their smartphone, tablet, or computer. In addition, a computer chip the window panel or motherboard will be capable of transmitting messages to be displayed on the window slate when it is closed, or there will be an incoming message notification to signal the owner.

Extremely convenient to use. and featuring cleverly designed, one-way see-through blind slats, the tint of which can be adjusted in accordance to personal preference or lighting conditions, the Major Blinds would enable consumers to block harsh sunlight from entering their homes, while still enjoying an unobstructed view out through the window on which the blinds are installed.

Consumers should appreciate that even if the blinds are completely closed, they could still look out their window in order to keep a close watch on their children playing in the yard, or to simply enjoy a cultivated landscape with a one-way view, homeowners could look out through their windows, while preventing strangers or passersby from peering into one's home. Perhaps most importantly, the absence of pull strings for raising and lowering the blinds would make major blinds ideal for homes with pets and small children, as there are no dangling parts that could cause injury or worse, Death. An innovative product invention, Major Blinds would offer consumers the ultimate combination of convenience, Privacy and style for their homes.

Product Specifications

A basic, functional element of any home decor is a window. Windows can set the tone for a room, creating a pleasant mood through bright, sunny light and a direct view of the outdoors. Because windows let in vibrant sunshine, most consumers find it necessary to attach vertical window blinds inside their windows, in order to offer necessary shade. Additionally window blinds are used to protect the homeowner's privacy, particularly in the evening hours when light shining from overhead lights and floor lamps illuminate through the window I, offering passersby a free view into the home. Produced in a variety of sizes and colors, as well as a broad selection of materials such as aluminum, plastic and wood, window blinds are a necessary item found in most households.

Although indeed a practical necessity, use of window blinds is not without drawbacks. Many consumers find it frustrating that a set of window blinds can obstruct one's view of the outdoor, even if the blinds are adjusted so that the blind slats are open. This problem is only made worse when the blinds are completely closed. Simply stated, in order to block the harsh sunlight from entering one's room, window blinds must be closed so to completely encompass the surface of the window. As such, the homeowner is denied the pleasure of peering out their window in order to enjoy a carefully manicured lawn or even pretty rose garden during the daylight hours. In addition to the aforementioned problem, adjusted blinds to a preferred setting can sometimes be an annoying, time-consuming task. Manually operated, these window covers have to be raised and lowered via a set of pull strings, and opened and closed with an elongated, twisting rod. As many consumers would attest, it can be a bit frustrating to have to stop in the middle of cooking dinner or to leave cook comforts of an easy chair to adjust and readjust blinds settings as the light changes. The tools for operating window blinds also contain their own set of challenges. Connected to the unit by only a flimsy hook through a thin slot, the twist rod is used so often that it is easily broken, resulting in the expensive replacement of the blinds. Perhaps the most devastating drawback associated with window blinds, however, is that the dangling pull strings utilized to operate the blinds can be very dangerous, presenting a hazard in homes with small children. In fact, according to the consumer products safety commission, every two weeks, a child loses their life due to strangulation caused by window blinds cords. Recognizing the need for window blinds that are more efficient, convenient and safe, Olayinka Adebiyi has conceived of a new product invention he has designated the Major Blinds. The Major Blinds are a set of window blinds that can be easily opened and closed via a handheld remote-control unit. Eliminating much of the operational hardware germane to standard window blinds, the Major Blinds would also boast the added feature of having tinted, UV-resistant slats, with the level of tint that comprises the surface of the slats also remotely operated. The Major Blinds could be configured with either vertical or horizontal slats, with the slats themselves manufactured of a lightweight Plexiglass, glass, vinyl, plastic or comparable, clear, tinted material. The tinted material that comprises the blind slats would be configured so that the surface of the blinds would be see-thru when fully closed in a similar manner as if peering through tinted auto glass, yet the exterior of the blinds would obstruct the view of the interior of the room in which the blinds are installed, in a similar effect to one-way glass. In this manner, the Major Blinds would provide an unfettered view of the outdoors, even when the blinds are closed, while also protected the user's privacy and personal security in the process. The tint offered in the Major Blinds line could include standard amber tint common to adjustable window tint, or this see-through tint could be made available in a variety of colors to compliment various home decors. Importantly this tint would be fully adjustable, with five degrees of tint ranging from one (being the lightest) to 5 (being the darkest) available, with this tint modified via electrical power. The second main component of the Major Blinds is found in their remote operations. Unlike standard window treatments, the Major Blinds would not contain the turning rod or pull strings common to those models, rather, these tinted window blinds would be connected to an electronic motor that adjusts the positioning of the blinds, on demand. As such, the Major Blinds would feature an electronic receiver circuit, along with a tuned frequency necessary for the remote operation of the window blinds. Serving as the transmitter for the Major Blinds, and independent remote control device would be included for use with the blinds and would be rectangular in shape and comparable in size to a standard television remote control device. Located on the front panel of this remote would be a simple on/off switch, as well as directional buttons for use in raising, lowering and opening and closing the blinds. Operational settings would also be included for controlling the degree of tint that encompasses the surface of the individual blind slats. As with standard remote control devices, the interior components of the remote control would be comprised of a frequency generator, amplifier, internal antenna, and the required electrical/electronic components and circuitry, all encased within the unit's durable plastic housing. The Major Blind remote could be powered by a rechargeable battery source such as lithium, nickel-cadmium, or nickel-metal hydride, while the blinds themselves could feature a standard power cord, to be connected to a traditional power outlet and operating on conventional 110 volts, 60 hertz power.

Use of Major Blinds would be very simple and straightforward. First, the user would determine what sizes blinds are needed by carefully measuring each window area to be covered. Once the correct size has been ascertained, the user would then choose whether they wanted vertical or horizontal blinds, selecting Major Blinds in the desired tint. The Major Blinds could be installed on virtually any window, as well as over sliding glass doors. To open the slats of the blinds, the user would simply point the remote control at the window and press the designated button, opening the blinds and infusing the room with light. The user could also adjust the positioning of the blind slat so that the Major Blinds were partially opened at the desired angle. To adjust the degree of tint of the blinds, the user would simply select the remote control setting as desired, with the user selecting the option of one for a very light tint and 5 for a dark tint. Whether opening the blinds or adjusting the tint of the blind slats, the remote unit would function in the same manner: the companion receiving unit, located in the blinds, would ne tuned to specific frequency generated by the transmitter unit. Upon reception of the signal generated by the transmitter, the circuitry in the receiver would generate an “enable” signal to logic device (an “AND” integrated circuit chip or comparable), which would apply a voltage level to the unit, obeying the commands set forth by the button selection.

There are several significant benefits and advantages associated with this unique product invention. Foremost, the Major Blinds would offer consumers attractive window coverings that are extremely convenient, easy and safe to use. Featuring cleverly designed one-way, see-through blind slats, the tint of which can be adjusted in accordance to personal preference or lighting conditions, the Major Blinds would enable consumers to block harsh sunlight from entering their homes, while still enjoying an unobstructed view out through the window on which the blinds are installed. Consumers should appreciate that even if the blinds were completely closed, they could still look out their window in order to keep a close watch on children playing in the yard, or simply in order to enjoy a carefully cultivated landscape. With the adjustable tint that comprises the Major Blinds featuring a one-way view, homeowners could look out through their windows, while preventing strangers or passerby from peering into one's home. Protecting the user's privacy, the Major Blinds would enable homeowners to enjoy a measure of confidence and comfort within their homes, with the tint easily adjusted in accordance to the time of day or weather conditions. Consumers should especially appreciate that the Major Blinds would be operated by remote control, allowing for adjustment of the blind's tint or the positioning of the blinds slats, from practically any vantage point in the room. In this manner, a consumer could open the blinds for morning light while enjoying breakfast in bed, or lowering the blinds to reduce glare on the TV screen while sitting on the couch. As the Major Blinds do not need a turning rod for opening and closing, this practical product would eliminate the costly hassle that broken rods entail. Perhaps most importantly, the absence of pull strings for raising and lowering the blinds would make Major Blinds ideal for homes with small children, as there are no dangling parts that could cause injury, or worse. An invaluable safety tool, use of the Major Blinds could effectively prevent the serious accidents, injuries and even fatalities which occur every year as a result of dangling window blind cords. In this manner, the Major Blinds would prove ideal for a child's nursery, bedroom or playroom, offering parents the peace of mind that their little one would be safe from injury and harm. Easily installed with standard households tools, the Major Blinds would be well suited for virtually any room in the house. Although designed specifically for household use, the Major Blinds could be utilized in any public or private building. Made of durable, high-quality materials and components, the Major Blinds should withstand years of continued use.

An innovative product invention, the Major Blinds would offer consumers the ultimate combination of convenience, privacy, and style for their homes. Featuring a sophisticated electronic transmitting and receiving system, this practical product would enable consumers to operate their blinds in a simple and safe manner. Affordably priced, the Major Blinds should be well received by general household consumers, a very sizable market potential.

1. (canceled)

2. A window blind comprising:
a plurality of slats made from tinted material.
